(19) United States
(12) Patent Application Publication
(10) Pub. No.: US 2009/0129452 A1
(43) Pub. Date: May 21, 2009

(54) Method and Apparatus for Producing a Desired Data Compression Output

(76) Inventors: Yanjun Xu, Plainsboro, NJ (US); Charles Dieterich, Kingston, NJ (US); Sandip Parikh, Monmouth Junction, NJ (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/941,049

(22) Filed: Nov. 15, 2007

(51) Int. Cl. H04B 17/00; H04B 1/66

(52) U.S. Cl. 375/224; 375/241

(57) ABSTRACT

A method and apparatus for testing the functionality of a data decoder is provided. The functionality of a decoder is examined through the used of a functional bitstream. The functional bitstream is a bitstream which when decoded by a properly functioning decoder, produces a desired output. Such a bitstream can be created by receiving an input bitstream, compressing the input bitstream, thereby creating a compressed input bitstream. The compressed input bitstream is then decompressing, thereby creating an intermediate bitstream. The intermediate bitstream is then compressed, thereby creating a compressed intermediate bitstream. The compressed intermediate bitstream is then decompressed, thereby creating an output bitstream. Finally, a comparison is performed to determine if the output bitstream is equivalent to a desired bitstream.

### BACKGROUND OF THE INVENTION

1. Field of the Invention

The present invention is related to the field of digital compression. More particularly, the present invention is directed to a method of video encoding, which facilitates the production of a desired picture value.

2. Description of the Prior Art

The process of data compression is implemented to reduce the size of large data files. This reduction in size allows for more efficient data transfer over telecommunication networks, as well as better utilization of data storage space. Generally, data compression functions on the premise that much of the data within a given file is redundant, and therefore, by minimizing this redundancy the overall size of a file can be greatly reduced. In order to successfully reduce the redundancy of a given file, while still retaining the ability to utilize the file for its intended use, a file must undergo compression and decompression. Compression is the process of locating and removing redundancies, while retaining enough data to recreate a usable copy of the original file. Decompression is the process of recreating the original file based on the compressed data. Accurate execution of this process is facilitated when both compression and decompression are performed using the same compression protocol.

Over the years, many different data compression protocols have been developed. Most data compression protocols fall into one of two categories, either lossless or lossy. A lossless compression protocol manipulates the data is such a way, as to allow for the exact reconstruction of the original data file upon decompression. In contrast, when a data file is compressed by way of a lossy protocol, recreation of an exact copy upon decompression is not achievable. This is a by-product of the fact that during the initial lossy file compression, some of the data required in the reconstruction of a replica of the original file is typically lost. In most instances, the resulting imperfections in the output of a lossy protocol will go undetected by the average human observer. In the case of an audio file, compressed with a protocol like MP3 or AAC, the average human ear cannot detect the missing data and therefore listeners are unaware that they are listening to an audio file which is not an exact copy of the original. In the case of video, protocols like MPEG-2 and B.264 create compressed video images with a lossy output which, in most cases, cannot be detected by the human eye.

Video compression uses a large number of lossy compression standards. When such standards are used, they can result in the production of imperfect decompression. This can occur when a file is compressed by an encoder using a given compression protocol, but the file is later decompressed by a second decoder which is running a slightly different implementation of the same protocol. As a result of this disparity, testing of a decoder becomes challenging. There is a need for a scheme that compresses video, in such a way as to produce a compressed file or a bitstream, which, when decompressed by a properly functioning decoder, will produce a desired output. One method of ensuring that a decoder is functioning properly is to compare the pre-compression data with the post-compression data. If the data values are equal, then it can be determined that the decoder is functioning properly, as described in Equation 1. Where R0 represents the verification region, R2 represents the test region, invDCT_invQ_Q_DCT( ) represent the process of compression and decompression, and Prediction( ) represent the process of image prediction.

R0=Prediction(R2)+invDCT_{—}invQ_{—}Q_{—}DCT(R0−Prediction(R2)) (1)

However, the lossy nature of many compression protocols makes this type of equivalency testing extremely difficult, if not impossible. Despite the fact that the output from a lossy data compressing scheme might appear to be equal as judged by the human eye or ear, at the bit level a computer will not view the two samples as equal. The loss of functionally irrelevant data during the process of compression and decompression makes a straight forward equivalency test impractical. Another testing method currently used in the industry is to employ a known good decoder to uncompress a test bitstream, thereby producing a known good output. An equivalency test can be run between the known good output and the output produced by the questionable decoder. This method has limitations because it requires a known good decoder as well as a means to store, produce, process, and interrupt large amounts of known good results. Thus, there is a need in the art for an improved method and apparatus of testing the functionality of some lossy decoders.

### SUMMARY OF THE INVENTION

Embodiments of the invention satisfy this and other needs. Embodiments of the invention are directed to methods of encoding a video bitstream, which when decoded by a properly functioning decoder, produces a picture value as desired. This process can be used to accurately and efficiently test the functionality of data compression decoders.

A method, in accordance with some embodiments, is a process of producing an desired value. This method can be utilized by H.264 or other similar data coding and compression schemes. By utilizing the loop back functionality within each encoder, the method performs an intermediate step of compression and decompression in order to produce a functional bitstream which, when decoded by a questionable decoder, will produce a desired value. The functional bitstream represents a bitstream which, when decompressed by a properly functioning decoder, produces a desired output. However, the functional bitstream is created in order to ensure that in certain video regions, the output of a questionable decoder will be equal to a desired region. Certain circumstance may require that more than one intermediate step be utilized in order to produce the correct functional bitstream. The process of using an intermediate step can be utilized in instances of both inter and intra prediction, which types of prediction are known to those of skill in the art.

Although not limiting the possible options of desired values that may be used by embodiments of the current invention, it is known that the use of a “prefect grey” image provides for easy assessment as to the functionality of a decoder. As used herein, a “perfect grey” image is one in which the pixel luma and chrominance values are both 128. However, the desired value could be any value which is chosen to determine if the questionable decoder has produced the correct output test region.

The scope of the current invention is not limited to the method and apparatus of utilizing a single encoder to receive a test region, generate a functional bitstream, and produce an output test region. Embodiments of the present invention also include a method and apparatus for employing a functional bitstream generated by one encoder and transmitting to a second a questionable decoder. This transmission could be accomplished by, for example, means of remote electronic transfer or through manual transfer via data storage device.

The benefits of the embodiments are accomplished in accordance with the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a flow diagram of a system for generating an output test region through use of an intermediate region;

FIG. 2 is a flow diagram of a system of producing a desired output region using one intermediate prediction step;

FIG. 3 is a flow diagram of a process that can be utilized to determine the proper values to be used as the quantization parameters as well as pixel value for the intermediate region;

FIG. 4 is a flow diagram of a system for generating an output test region through use of an one or more intermediate regions; and

FIG. 5 is a flow diagram of a process in which multiple intermediate regions are utilized to produce an output region.

### DETAILED DESCRIPTION OF THE DRAWINGS

The present invention is directed to a method of coding a bitstream, which when decoded by a properly functioning decoder, produces a desired picture region. For the purpose of clarity, and not by way of limitation, illustrative views of the present invention are described with references made to the above-identified figures. Various modifications obvious to one skilled in the art are deemed to be within the spirit and scope of the present invention.

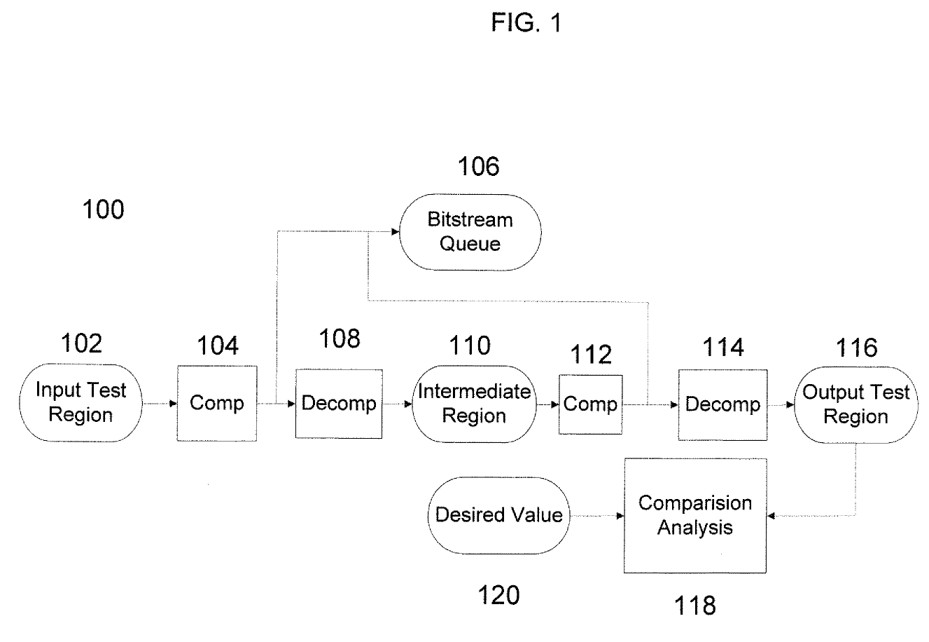

FIG. 1 is a flow diagram which describes an embodiment of the current invention. The embodiment describes a method 100 which begins when an input test region 102 undergoes the process of data compression 104. The process of data compression 104 produces two like compressed bitstream outputs. One of the compressed bitstreams travels to the compressed bitstream queue 106. The second compressed bitstream travels to the decompression process 108, where the compressed bitstream undergoes decompression. The output of the decompression process 108 is intermediate region 110. The intermediate region 110 is produced as a result of compressing and decompressing the input test region 102. Given that the method is primarily used for lossy compression protocols, the bitstream representing the intermediate region 110 and the bitstream representing the input test region 102 will vary slightly. The intermediate region 110 then undergoes data compression 112. The process of data compression 112 produces two like compressed bitstream outputs. One of the compressed bitstreams travels to the compressed bitstream queue 106. The bitstream produced in this second compression process 112 is appended to the initial bitstream already located in the compressed bitstream queue 106. The second compressed bitstream, which is exiting the compression process 112, travels to the decompression process 1164, where the compressed bitstream undergoes decompression. The output of the decompression process 114 is output test region 116. The output test region then undergoes comparison analysis 118. The comparison analysis 118 determines if the output test region 116 is equivalent to the desired value 120. Comparison analysis can be accomplished via visual examination, computerized analysis, or other method known to one skilled on the art. If the output test region 116 is equivalent to the 120 desired value, then is can be established that the bitstream in the compressed bitstream queue 106 is a functional bitstream.

Although any image could be used as a desired value 112, it has been shown that the use of perfect grey, as the desired value 112, allows for easy verification. Its location half-way between both white and black makes it easy to determine if the decoder is functioning properly.

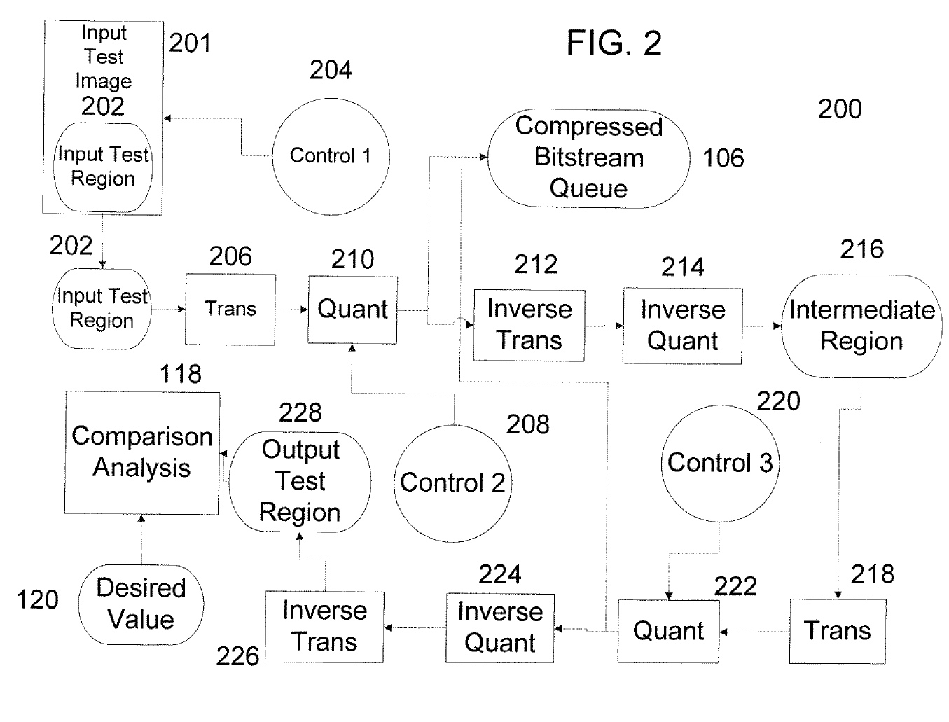

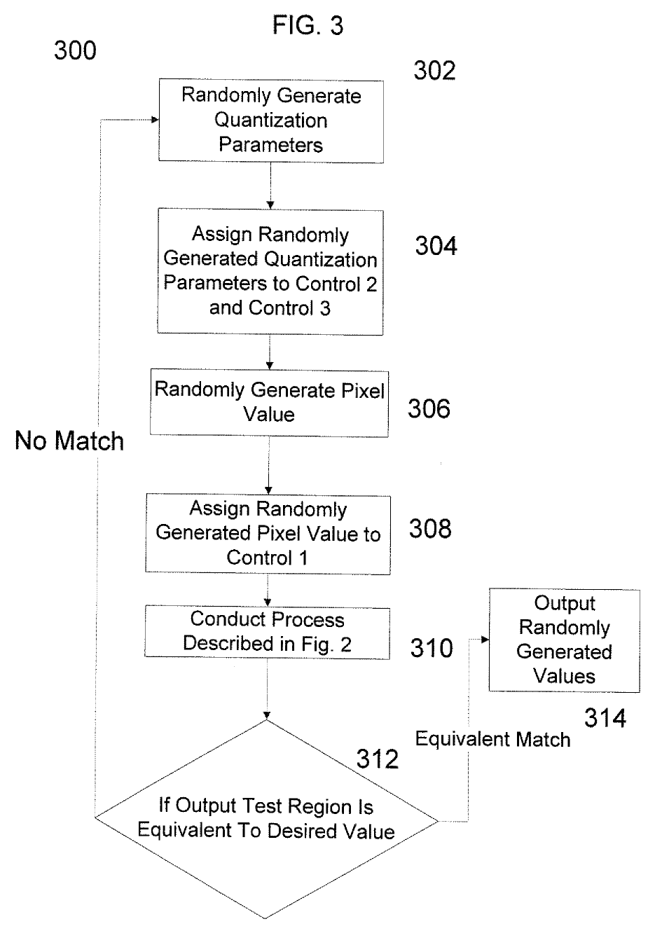

FIG. 2 depicts a flow diagram for a method of producing a functional bitstream, which when decompressed will produce a desired result. It is important to note the all steps described, with respect to FIG. 2, may occur within a single encoding device. Alternatively, the process could be preformed by one or more devices. The process begins with the selection of the control parameter. In the current method 200 there are three control parameters. Control 1 (204), Control 2 (208), and Control 3 (220). Both Controls 1 (208) and 3 (220) are used in the “quantization” process. As used herein, “quantization” refers to the process of extending or reducing resolution of representation of any value. Control 1 (204) is utilized in the process of selecting the test region from the test image. The selection of these values can be accomplished consistent with the method described in FIG. 3, or by any method which would be known to one skilled in the art. Having determined a set of control parameters, the input test region 202 is selected from the test image 201. The input test region 202 then undergoes “transformation” 206 which is followed by quantization 210. As used herein, “transformation” refers to the process by which pixel regions are processed to convert pixel regions to frequency components. Control 2 (208) governs the quantization parameters used during quantization 210. The process of quantization outputs two like compressed bitstreams. One of the compressed bitstream travels to the compressed bitstream queue 106. The second compressed bitstream travels to the “inverse quantization” process 212. As used herein, “inverse quantization” refers to the process where resolution of representation of any value is restored to a resolution which is similar to the resolution before quantization. The second compressed bitstream then undergoes inverse quantization 212 and “inverse transformation” 214, thereby producing intermediate region 216. As herein, “inverse transformation” refers to the process where frequency components are processed to convert them into pixel regions. Intermediate region 216 then undergoes transformation 218, and quantization 222 which produces a compressed bitstream. Control 3 (220) governs the quantization parameters used during the second phase of quantization 222. The process of quantization 222 outputs two like compressed bitstreams. One of the compressed bitstreams travels to the compressed bitstream queue 106. The bitstream produced in this second quantization process 222 is appended to the initial bitstream already located in the compressed bitstream queue 106. The second compressed bitstream then undergoes inverse quantization 224 and inverse transformation 226, thereby producing output test region 228. Once the current method 200 is complete, it can be determined whether the output region 228 represents the desired value 120. This comparison analysis 118 may be completed through visual examination, or by way of bit analysis. If the output test region 228 does not match the desired values 120, then the method 200 can be repeated. The method begins with the selection of new values for each control point. If the output test region 228 does match the desired value 120, then it can be established that the bitstream located in the compressed bitstream queue 106 is a functional bitstream.

FIG. 3 describes one method 300 that can be utilized in order to establish the proper values to be used as the pixel value as well and quantization parameters. This method 300 begins with the random generation 302 of two values to be used as quantization parameters. The randomly generated quantization parameters can fall within an appropriate range, given the data coding and compression scheme being utilized. These values are then assigned 304 to Control 2 (208) and Control 3 (220) to be used in the process of quantization. In addition to randomly generating the parameters to be used in the process of quantization, the current method 300 randomly generates the pixel values 306 to be used in the process of selecting an input test region. This method 300 then randomly generates the pixel value 306 which is then assigned 308 as the value to be as Control 1 (204). This pixel value is employed in the method of selecting the test region 202 from the input test image 201. Once the quantization parameters and pixel values have been generated and assigned, the process described in FIG. 2, or other like data compression and comparison method, is executed. If this process produces a functional bitstream, then it can be stated that proper quantization and pixel values have been chosen. If a functional bitstream in not produced, then the quantization and pixel values are not adequate, and the current method 300 can begin again, with the generation of new quantization parameters 302. It should be noted that FIG. 3 describes one embodiment of a process by which quantization and pixel values can be selected. Some of these steps could be combined or conducted in a different order, while still producing the same result in accordance with embodiments of the invention. The possible variations which would be known to one skilled in the art, as informed by the present disclosure are included within the scope of this invention.

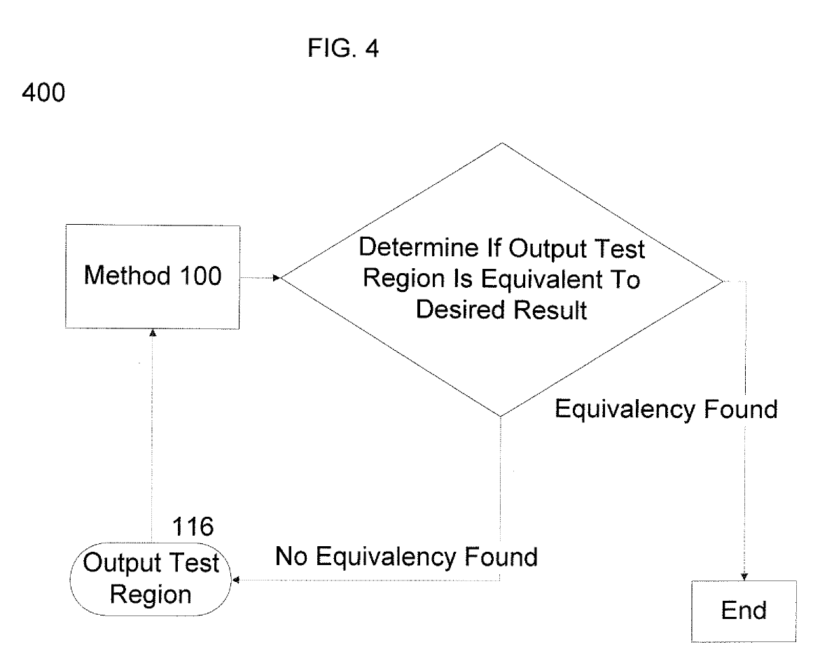

With reference to FIG. 4, with continued reference to method 100, as described in FIG. 1, FIG. 4 describes an iterative method of producing a functional bitstream. Method 400 begins with the execution of method 100. If the output test region 116 is found to be equivalent to the desired value 120 then it is determined that a functional bitstream has been produced. However, if the output test region 116 is not equivalent to the desired value 120, then method 100 begins again with the output test region 116 being used as the input test region 102 for the next iteration of method 100. This process will continue until the output test region 116 is found to be equivalent to the desired value 120. Equivalency could be found where the values are equal, or within a desired threshold. Once this equivalency is found, it can be determined that the bitstream within the compressed bitstream queue 106 is a functional bitstream.

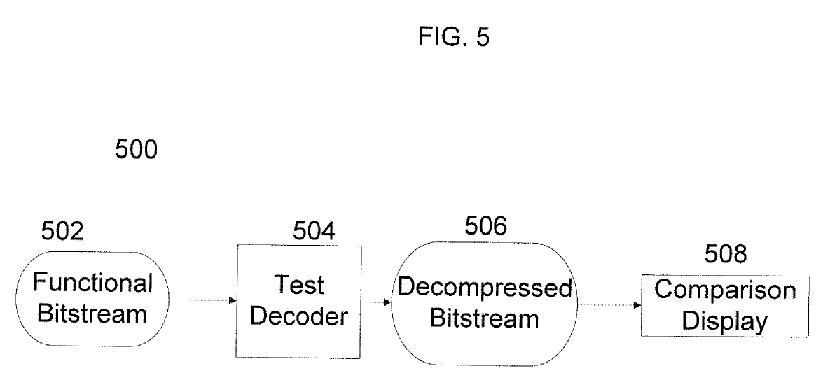

FIG. 5 describes a method 500 of utilizing the functional bitstream to determine if a decoder is properly functioning. The functional bitstream could be produced through the process described in FIG. 2, as well other embodiments of the current invention. The current method 500 begins when the functional bitstream 502, arrives at the test decoder 504. The compressed bitstream could arrive at the test decoder 504 through remote electronic transfer, or be way of physical input from a data storage device. The test decoder 504 performs inverse quantization and inverse transformation and thereby decompresses the compressed functional bitstream. The test decoder 504 then transmits the decompressed bitstream 504 to a comparison display 508. Upon examining the visual representation of the decompressed bit steam, the tester can determine whether the visualization actually represents the desired image. If the visualization does represent the desired image, the test decoder 504 is said to be properly functioning, if visualization does not match the desired result, then the decoder did not properly decompress the input bitstream. The comparison process described could be conducted by an automated method without the use of a visual display. It could also be conducted on the same device that performed the data decompression. Other known methods of comparing bitstreams could be utilized in order to determine if the decoded bitstream is equivalent to the desired output. For example, the output region may be checked, via a computer, to ensure that all pixel values are perfect grey (i.e. equal to 128).

One skilled in the art will appreciate that the present invention can be practiced by other than the described, embodiments, which are present for purposes of illustration and not by way of limitation, and the present invention is limited only by the claims that follow.

What is claimed is:

1. A method of producing a desired bitstream, comprising:
receiving an input bitstream;
compressing the input bitstream, thereby creating a compressed input bitstream;
decompressing the compressed input bitstream, thereby creating an intermediate bitstream;
compressing the intermediate bitstream, thereby creating a compressed intermediate bitstream;
decompressing the compressed intermediate bitstream, thereby creating an output bitstream;
comparing the output bitstream and a desired bitstream;
if the output bitstream is equivalent to the desired bitstream, determining that the compressed input bitstream is a desired bitstream; and
if the output bitstream is not equivalent to the desired bitstream, determining that the compressed input bitstream is not a desired bitstream.

2. The method of claim 1, wherein a copy of the compressed input bitstream and a copy of the compressed intermediate bitstream is stored in a queue.

3. The method of claim 2, wherein the copy of the compressed input bitstream is appended to the copy of the compressed intermediate bitstream.

4. A method of testing the functionality of a decoder, comprising
acquiring a bitstream, by the decoder;
compressing the bitstream, by tire decoder, to create a compressed bitstream;
decompressing the compressed bitstream, by the decoder, to create an output bitstream;
comparing the output bitstream and a desired bitstream;
if the output bitstream is equivalent to the desired bitstream, determining that the questionable decoder is functioning properly; and
if the output bitstream is not equivalent to the desired bitstream, determining that the questionable decoder is not functioning properly.

5. An apparatus for producing a functional bitstream comprising:
a first data compression and decompression module, configured to receive an input value and perform data compression, create and store a copy of the compressed input value, and perform decompression upon the compressed input value, thereby creating an intermediate value;
a second data compression and decompression module, configured to receive the intermediate value and perform data compression, store a copy of the compressed intermediate value, and perform decompression upon the compressed intermediate value, thereby creating an output value; and
a data comparison module, configured to compare similarities between the output value and a second value whereby if output value and second value are equivalent the compressed input value appended to the compressed intermediate value is said to be a functional bitstream.
